(19) United States
(12) Patent Application Publication
(10) Pub. No.: US 2022/0326463 A1
(43) Pub. Date: Oct. 13, 2022

(54) OPTICAL FIBER CABLE AND MANUFACTURING METHOD FOR OPTICAL FIBER CABLE

(71) Applicant: SUMITOMO ELECTRIC INDUSTRIES, LTD., Osaka-shi, Osaka (JP)

(72) Inventors: Yohei SUZUKI, Osaka-shi, Osaka (JP); Fumiaki SATO, Osaka-shi, Osaka (JP); Yoshiaki NAGAO, Osaka-shi, Osaka (JP)

(73) Assignee: SUMITOMO ELECTRIC INDUSTRIES, LTD., Osaka-shi, Osaka (JP)

(21) Appl. No.: 17/616,712

(22) PCT Filed: Jun. 3, 2020
(86) PCT No.: PCT/JP2020/021985

§ 371 Date: Dec. 6, 2021

(30) Foreign Application Priority Data
Jun. 7, 2019 (JP) 2019-107432

(51) Int. Cl. G02B 6/44

(52) U.S. Cl. CPC G02B 6/4434; G02B 6/448

(57) ABSTRACT

An optical fiber cable includes a slot rod that is provided with a plurality of slot grooves in a spiral shape stranded in one direction, a tensile strength member that is provided inside the slot rod to receive tension, a cable sheath that covers an outer side of the slot rod, and a plurality of optical units made by gathering optical fiber ribbons in which a plurality of optical fibers is arranged in parallel. In each of the optical units, the optical fiber ribbons are stranded with each other along a longitudinal direction of the optical fiber cable. Each of the optical units is accommodated in corresponding one of the slot grooves along the longitudinal direction in a state where relative positional relationships between the optical units and the slot grooves are kept and relative positional relationships between the optical units are kept.

### TECHNICAL FIELD

The present disclosure relates to an optical fiber cable and a manufacturing method for the optical fiber cable.

The present application claims priority from Japanese Patent Application No. 2019-107432 filed on Jun. 7, 2019, contents of which are incorporated by reference in its entirety.

### BACKGROUND ART

Patent Literature 1 discloses an optical fiber cable in which a plurality of optical fiber units are stranded with each other in a slot groove formed in a spiral shape in one direction or two directions.

Patent Literature 2 discloses an optical fiber cable having a configuration in which when W is a groove width of an accommodation groove on an outer peripheral side of a slot, D is a groove depth of the accommodation groove along a radial direction of the slot, S1 is a cross-sectional area of the accommodation groove orthogonal to a shaft direction of the slot, and S2 is a total cross-sectional area of optical fibers accommodated in the accommodation groove, S2/S1≤0.6 and S2/S1≤0.2(W/D)+0.3 are satisfied.

Patent Literature 3 discloses an optical fiber cable in which an optical unit is accommodated in a slot groove in a stranded state, and an occupancy rate of the optical unit calculated based on a cross-sectional area of the optical unit with respect to a cross-sectional area of the slot groove is 25% or more and 60% or less.

### CITATION LIST

### Patent Literature

Patent Literature 1: JP-A-2016-133611

Patent Literature 2: JP-A-2016-75814

Patent Literature 3: JP-A-2017-32749

### SUMMARY OF THE INVENTION

An optical fiber cable according to an aspect of the present disclosure includes:

a slot rod that is provided with a plurality of slot grooves in a spiral shape stranded in one direction; a tensile strength member that is provided inside the slot rod and configured to receive tension;

a cable sheath that covers an outer side of the slot rod; and

a plurality of optical units each of which is made by gathering optical fiber ribbons in which a plurality of optical fibers is arranged in parallel.

In each of the optical units, the optical fiber ribbons are stranded with each other along a longitudinal direction of the optical fiber cable.

Each of optical units is accommodated in corresponding one of the slot grooves along the longitudinal direction of the optical fiber cable in a state where relative positional relationships between the optical units and the slot grooves are kept and relative positional relationships between the optical units are kept.

According to an aspect of the present disclosure, a manufacturing method for an optical fiber cable, the optical fiber cable including:

a slot rod that is provided with a plurality of slot grooves in a spiral shape stranded in one direction;

a tensile strength member that is provided inside the slot rod and configured to receive tension;

a cable sheath that covers an outer side of the slot rod; and

a plurality of optical units each of which is made by gathering optical fiber ribbons in which a plurality of optical fibers are arranged in parallel,

the method includes:

a process of forming the optical unit by stranding back the plurality of optical fiber ribbons sent out from supply units of the optical fiber ribbons so as to be stranded with each other; and

a process of accommodating the plurality of optical units in the slot grooves along a longitudinal direction of the optical fiber cable in a state where relative positional relationships between the optical units and the slot grooves are kept and a relative positional relationship between the optical units are kept.

### BRIEF DESCRIPTION OF DRAWINGS

FIG. 1 is a cross-sectional view showing an example of an optical fiber cable according to the present embodiment.

FIG. 2 is a view showing a spiral structure of a slot rod in the optical fiber cable of FIG. 1.

FIG. 3 is a view showing a stranded structure of an optical unit in the optical fiber cable of FIG. 1.

FIG. 4 is a view showing an example of an intermittent connection-type optical fiber ribbon.

FIGS. 5A and 5B are views for illustrating a state of the optical unit and the optical fiber ribbon in a slot groove in the optical fiber cable of FIG. 1.

FIGS. 6A and 6B are views for illustrating a state of the optical unit and the optical fiber ribbon in the slot groove in the optical fiber cable of FIG. 1, and are views showing a position shifted by ⅓ spiral pitch of the slot rod in a stranding direction from a position in a longitudinal direction of FIG. 5A.

FIG. 7 is a view for illustrating a step of manufacturing the optical unit in a manufacturing method for the optical fiber cable according to the present embodiment.

FIG. 8 is a view for illustrating the step of manufacturing of the optical unit in the manufacturing method for the optical fiber cable according to the present embodiment, and is a view seen from an H direction in FIG. 7.

FIG. 9 is a view for illustrating a step of accommodating the optical units in the slot grooves of the optical fiber cable in the manufacturing method for the optical fiber cable according to the present embodiment.

### DESCRIPTION OF EMBODIMENT

### Technical Problem

A slot-type optical fiber cable has a structure in which when a slot groove is an SZ type slot groove, intermediate branching is easily performed at a portion where a stranding direction of the groove is reversed, whereas when the slot groove is a slot groove having a spiral shape stranded in one direction, since there is no portion where the stranding direction of the groove is reversed, the intermediate branching may not be easily performed. Further, when a plurality of optical units in which a plurality of optical fiber ribbons are gathered are accommodated in each of a plurality of slot grooves, it may not be easy to take out a desired optical fiber ribbon.

In addition, since the slot-type optical fiber cable has a tensile strength member at a center, the tensile strength member becomes a bending center when the optical fiber cable bends, and a compressive stress is applied to optical fibers on an inner side from the bending center. When the optical fiber ribbons are mounted at low density, since a space in the slot groove is large, the optical fibers can be easily moved in a longitudinal direction of the optical fiber ribbon. The optical fiber ribbons move, so that a tensile stress and the compressive stress cancel each other, and thus, a significant increase in loss is less likely to occur. On the other hand, when the optical fiber ribbons are mounted at high density, the optical fibers are difficult to move in the longitudinal direction, and thus, when the optical fibers cannot withstand a compressive strain, the optical fibers may protrude from the slot groove. When the optical fiber protrudes, a macrobend loss may occur in the protruding portion, and transmission characteristics may be deteriorated.

An object of the present disclosure is to provide an optical fiber cable and a manufacturing method for the optical fiber cable capable of easily taking out a desired optical fiber ribbon at the time of intermediate branching.

### ADVANTAGEOUS EFFECTS OF INVENTION

According to the present disclosure, it is possible to provide an optical fiber cable and a manufacturing method for the optical fiber cable capable of easily taking out a desired optical fiber ribbon at the time of intermediate branching.

### Description of Embodiments of Disclosure

First, embodiments of the present disclosure will be listed and described.

An optical fiber cable according to an aspect of the present disclosure includes:

(1) a slot rod that is provided with a plurality of slot grooves in a spiral shape stranded in one direction;

a tensile strength member that is provided inside the slot rod and configured to receive tension;

a cable sheath that covers an outer side of the slot rod; and

a plurality of optical units each of which is made by gathering optical fiber ribbons in which a plurality of optical fibers are arranged in parallel.

In the each of the optical units, the optical fiber ribbons are stranded with each other along a longitudinal direction of the optical fiber cable.

each of optical units is accommodated in corresponding one of the slot grooves along the longitudinal direction of the optical fiber cable in a state where relative positional relationships between the optical units and the slot grooves are kept and relative positional relationships between the optical units are kept.

In the above-described optical fiber cable, the plurality of optical units are accommodated in the slot groove in the above-described state, and the optical units are not stranded with each other even when the slot groove is stranded in one direction. Therefore, a position of each optical unit in the slot groove is easy to understand, intermediate branching is easy to perform, and a desired optical fiber ribbon can be easily taken out at the time of the intermediate branching.

In the optical unit, the optical fiber ribbons are stranded with each other along the longitudinal direction of the optical fiber cable, and thus, it is possible to prevent deterioration of transmission characteristics caused by the protrusion of the optical fiber ribbons.

(2) A stranding direction of the optical fiber ribbons is the same as a stranding direction of the slot grooves in the spiral shape stranded in one direction, and

when a stranding pitch of the optical fiber ribbons is P1 and a stranding pitch of the slot grooves is P2,

a composite stranding pitch Pmix obtained by 1/Pmix=1/P1+1/P2 may be 200 mm or more and 400 mm or less.

In the optical fiber cable, since the composite stranding pitch Pmix is 200 mm or more, it is possible to prevent an increase in transmission loss due to microbend caused by an increase in volume of the optical units (an increase in optical fibers per unit length). In addition, in the optical fiber cable, the composite stranding pitch Pmix is 400 mm or less. Therefore, since the unit has a certain degree of volume, the tensile stress on an upper side of the cable and the compressive stress on a lower side of the cable due to the bending of the optical fiber cable can cancel each other out (counterbalance), and an increase in transmission loss can be prevented. Therefore, the optical fiber cable can obtain good transmission characteristics.

(3) An occupancy rate of the optical unit calculated based on a cross-sectional area of the plurality of optical units with respect to a cross-sectional area of the slot groove may be 25% or more and 65% or less.

Since the occupancy rate of the optical unit with respect to the slot groove is set to 65% or less, even when the optical fiber cable is bent in an arc shape, the compressive strain is dispersed without being concentrated on a part of the optical fibers. Therefore, the occurrence of the macrobend loss can be prevented, and cable bending characteristics can be improved. In addition, when the occupancy rate is set to 25% or more, the density can be increased. Therefore, even the optical fiber ribbons are mounted in the slot groove at high density, the transmission loss of the optical fibers can be reduced to be small.

(4) In the plurality of optical units, the optical fiber ribbons may be stranded in a state of stranding back.

When the optical fiber ribbons are stranded with each other as they are, torsion is generated in each of the optical fiber ribbons. In contrast, when the optical fiber ribbons are stranded in the state of stranding back, the torsion thereof can be eliminated. Therefore, it is possible to prevent the occurrence of the macrobend loss caused by the torsion of the optical fiber ribbons.

According to an aspect of the present disclosure, a manufacturing method for an optical fiber cable, the optical fiber cable including:

(5) a slot rod that is provided with a plurality of slot grooves in a spiral shape stranded in one direction;

a tensile strength member that is provided inside the slot rod and configured to receive tension;

a cable sheath that covers an outer side of the slot rod; and

a plurality of optical units each of which is made by gathering optical fiber ribbons in which a plurality of optical fibers is arranged in parallel,

the method includes:

a process of forming the optical unit by stranding back the plurality of optical fiber ribbons sent out from supply units of the optical fiber ribbons so as to be stranded with each other; and

a process of accommodating the plurality of optical units in the slot grooves along a longitudinal direction of the optical fiber cable in a state where relative positional relationships between the optical units and the slot grooves are kept and relative positional relationships between the optical units are kept.

According to the manufacturing method, the plurality of optical units are respectively accommodated in the plurality of slot grooves in the spiral shape stranded in one direction along the longitudinal direction of the optical fiber cable in a state in which the relative positional relationship between the optical units and the slot groove does not change and the relative positional relationship between the optical units does not change, so that the optical fiber cable can be manufactured. In the optical fiber cable manufactured by the above manufacturing method, a desired optical fiber ribbon can be easily taken out at the time of the intermediate branching.

### Details of Embodiments of the Present Disclosure

Specific examples of an optical fiber cable and a manufacturing method for the optical fiber cable according to an embodiment of the present disclosure will be described below with reference to the drawings.

The invention is not limited to these examples, and is defined by the scope of the claims, and is intended to include all modifications within the scope and meaning equivalent to the scope of the claims.

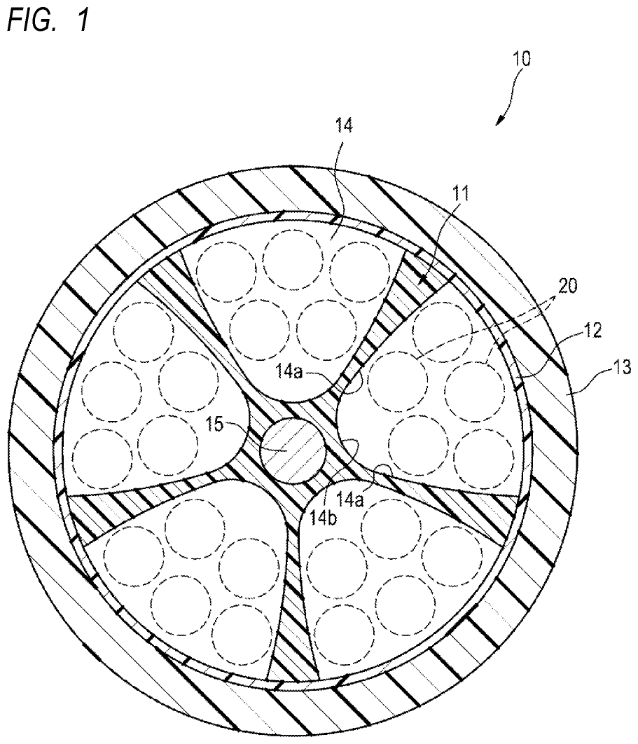

FIG. 1 is a view showing an example of an optical fiber cable according to the present embodiment.

As shown in FIG. 1, the optical fiber cable 10 of the present example includes a slot rod 11, a wrapping tape 12, a cable sheath 13, a tensile strength member 15, and optical units 20.

The slot rod 11 is provided with a plurality of (five in the present example) slot grooves 14 for accommodating the optical units 20. The slot grooves 14 are open toward an outer peripheral side of the slot rod 11, and are provided at equal intervals in a circumferential direction of the slot rod 11. The slot groove 14 is formed in a shape in which both side wall portions 14a gradually approach each other from the outer peripheral side of the slot rod 11 toward a center portion side. A bottom portion 14b of the slot groove 14 is a curved surface that is curved toward the center portion side of the slot rod 11.

The slot rod 11 is formed of, for example, a synthetic resin of polycarbonate (PC) and polybutylene terephthalate (PBT) or a hard resin material such as high-density polyethylene (HDPE). The tensile strength member 15 is embedded in a center portion of the slot rod 11. As the tensile strength member 15, a wire material having proof strength against tension and compression, for example, a steel wire, or fiber reinforced plastics (FRP) is used.

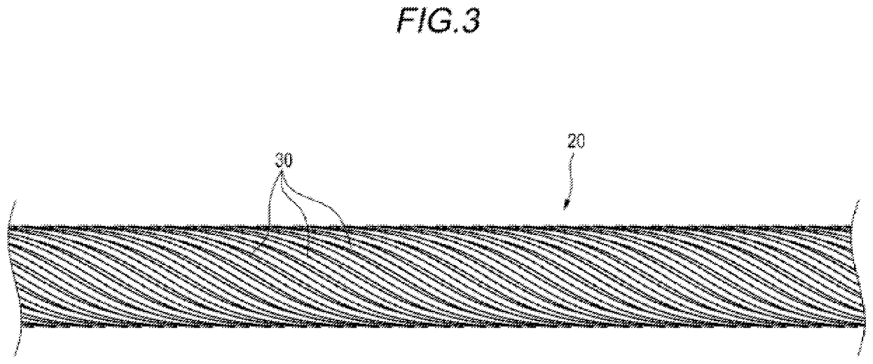

A plurality of (five in the present example) optical units 20 are accommodated in each slot groove 14 of the slot rod 11. The five optical units 20 are accommodated in the slot groove 14 in a state in which the optical units 20 are not stranded with each other. Each optical unit 20 is formed of a plurality of optical fiber ribbons (described later with reference to FIG. 3).

As the wrapping tape 12, for example, a tape obtained by forming nonwoven fabric in a tape shape, or a tape obtained by bonding a base material such as polyethylene terephthalate (PET) and the nonwoven fabric is used. Note that a water absorbing agent (for example, water absorbing powders) may be applied to the wrapping tape 12. When the wrapping tape 12 functions as a water absorbing layer, the optical units 20 or the like can be waterproof. An outer side of the wrapping tape 12 is covered with the cable sheath 13 made of, for example, polyethylene (PE), or polyvinyl chloride (PVC), and is formed in, for example, a round shape.

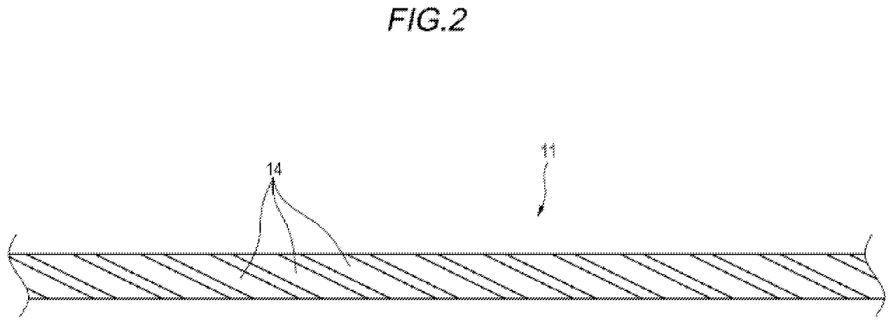

FIG. 2 is a side view of the slot rod 11. As shown in FIG. 2, the slot grooves 14 in the slot rod 11 are provided in a spiral shape stranded in one direction along a longitudinal direction of the slot rod 11. As described above, the plurality of (five in the present example) slot grooves 14 are provided on an outer peripheral surface of the slot rod 11 (see FIG. 1).

FIG. 3 is a side view showing the optical unit 20 accommodated in the slot groove 14. As shown in FIG. 3, the optical unit 20 is collected by stranding a plurality of optical fiber ribbons 30 with each other. In the optical unit 20 of the present example, six optical fiber ribbons 30 are stranded with each other. A stranding direction of the optical fiber ribbons 30 is the same as a spiral direction of the slot grooves 14 provided in the spiral shape stranded in one direction.

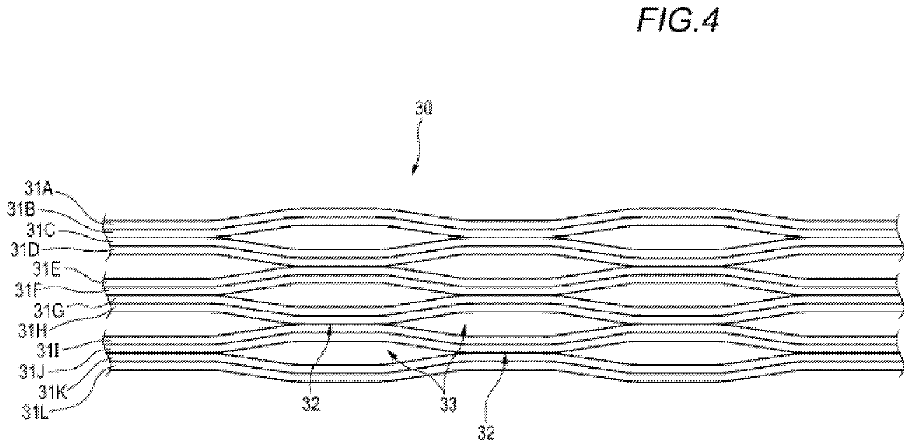

FIG. 4 shows an example of the optical fiber ribbon 30 constituting the optical unit 20. As shown in FIG. 4, the optical fiber ribbon 30 is an intermittent connection-type optical fiber ribbon. In the optical fiber ribbon 30, in a state in which a plurality of (twelve in the present example) optical fibers 31 (31A to 31L) are arranged in parallel, connecting portions 32 in which adjacent optical fibers 31 are connected to each other and non-connecting portions 33 in which adjacent optical fibers 31 are not connected to each other are intermittently provided in a longitudinal direction. FIG. 4 shows the intermittent connection-type optical fiber ribbon 30 in a state in which the optical fibers 31 are opened in the arrangement direction. Portions where the connecting portions 32 and the non-connecting portions 33 are intermittently provided may be between a part of the optical fibers or may be between all of the optical fibers. The optical fiber ribbon 30 shown in FIG. 4 has a configuration in which the connecting portion 32 and the non-connecting portion 33 are provided for each of two optical fibers.

The optical fiber ribbons constituting the optical unit 20 may not be the intermittent connection-type optical fiber ribbon, and may be an optical fiber ribbons in which all of the adjacent optical fiber ribbons are connected to each other by a batch coating resin (tape resin) extending along the longitudinal direction, but the optical fiber ribbons are preferably the intermittent connection-type optical fiber ribbons in order to achieve high density.

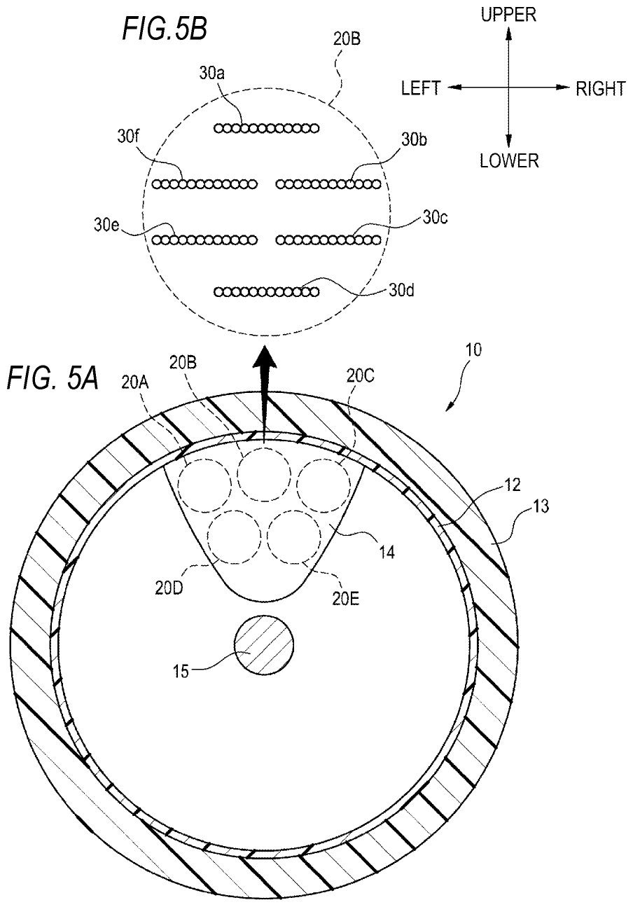

Next, an arrangement state of the optical units 20 and the optical fiber ribbons 30 in the slot groove 14 in the optical fiber cable 10 of FIG. 1 will be described with reference to FIGS. 5A 6B.

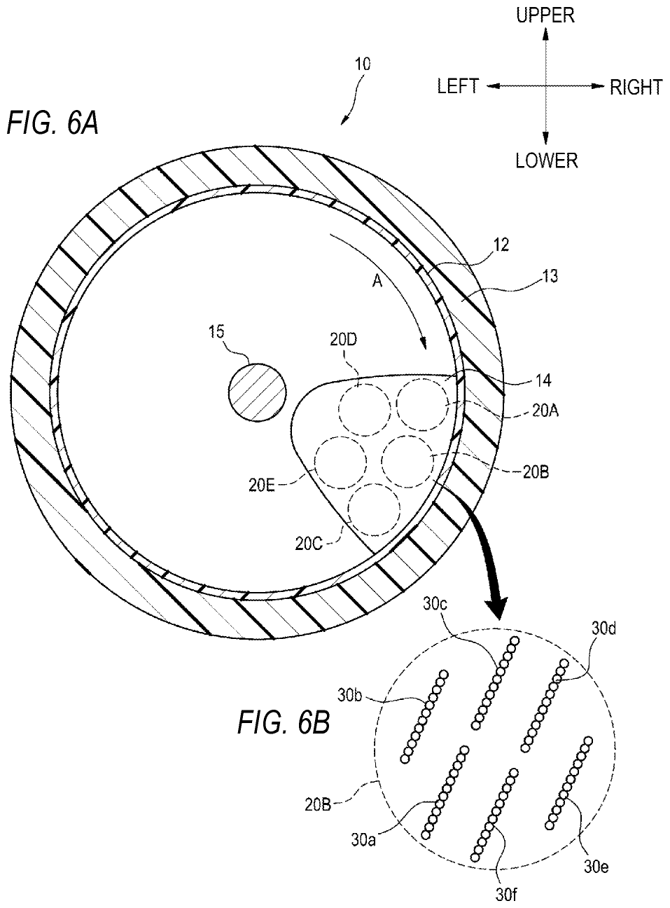

FIGS. 5A and 6A are cross-sectional views showing changes in orientation and position of the slot groove 14 in the longitudinal direction of the optical fiber cable 10, the optical units 20 (20A to 20E) accommodated in the slot groove 14, and the optical fiber ribbons 30 (30a to 30f) forming the optical unit 20. In FIGS. 5A and 6A, for convenience of description, only one slot groove 14 among the five slot grooves 14 shown in FIG. 1 is shown.

The slot groove 14 shown in FIG. 5A opens upward. With respect to the optical units 20 (20A to 20E), in the slot groove 14, the optical units 20A, 20B, 20C are arranged in parallel in a left-right direction in an upper side stage (an opening side of the slot groove 14) in FIG. 5A, and the optical units 20D, 20E are arranged in parallel in the left-right direction in a lower side stage (bottom side of the slot groove 14).

The plurality of optical fiber ribbons 30 (30a to 30f) are arranged in a width direction and a direction perpendicular to the width direction. In each of the optical units 20 (20A to 20E), the optical fiber ribbons 30 (30a to 30f) are arranged such that the width direction of the optical fiber ribbons 30 is, for example, a direction substantially parallel to an opening of the slot groove 14. In addition, the optical fiber ribbon 30a is arranged at an uppermost stage (the opening side of the slot groove 14) in FIG. 5B, and the optical fiber ribbon 30f and the optical fiber ribbon 30b are arranged in parallel in the left-right direction at a second stage from the uppermost stage. In addition, the optical fiber ribbon 30e and the optical fiber ribbon 30c are arranged in parallel in the left-right direction in a third stage from the uppermost stage, and the optical fiber ribbon 30d is arranged in a lowermost stage.

FIG. 6A is a cross section at a position shifted by ⅓ spiral pitch of the slot groove 14 in the stranding direction (arrow A direction) from a position of the optical fiber cable 10 in the longitudinal direction of FIG. 5A. For example, when a stranding pitch of the spiral stranded slot groove 14 is 600 mm, the position shifted by ⅓ spiral pitch is at a position shifted by 200 mm in the longitudinal direction of the optical fiber cable 10.

As shown in FIG. 6A, with respect to the optical units 20 (20A to 20E), the optical units 20 are accommodated in the slot grooves 14 formed in the spiral shape stranded in one direction along the longitudinal direction of the optical fiber cable 10 without being stranded back in a state where the optical units 20 are not stranded with each other. Therefore, with respect to the optical units 20 (20A to 20E), in the slot groove 14, the optical units 20A, 20B, 20C, which are arranged in parallel in the left-right direction at the stage on the opening side of the slot groove 14 at the position of FIG. 5A, are also arranged in parallel in the same order at the stage on the opening side of the slot groove 14 at the position of FIG. 6A.

In addition, the optical units 20D, 20E, which are arranged in parallel in the left-right direction at the stage on the bottom side of the slot groove 14 at the position of FIG. 5A, are also arranged in parallel in the same order at the stage on the bottom side of the slot groove 14 at the position of FIG. 6A. That is, the five optical units 20 (20A to 20E) in the slot groove 14 are accommodated in the slot groove 14 without changing a relative positional relationship between the optical units 20 and the slot groove 14. In addition, the five optical units 20 (20A to 20E) in the slot groove 14 are accommodated in the slot groove 14 without changing a relative positional relationship between the optical units 20.

For example, as shown in FIGS. 5A and 6A, the optical units 20 (20A to 20E) are accommodated in the slot groove 14, such that the optical units 20D, 20E positioned on the bottom side of the slot groove 14 are always positioned on the bottom side, and the optical units 20A, 20B, 20C positioned on the opening side of the slot groove 14 are always positioned on the opening side. Further, for example, the optical units 20A, 20E positioned on a left side toward the opening of the slot groove 14 are accommodated so as to be always positioned on the left side, and the optical units 20C, 20D positioned on a right side toward the opening of the slot groove 14 are accommodated so as to be always positioned on the right side.

In each of the optical units 20 (20A to 20E), the optical fiber ribbons 30 (30a to 30f) are stranded back along the longitudinal direction of the optical fiber cable 10 and stranded in the spiral shape stranded in one direction. That is, when the optical fiber ribbons 30 (30a to 30f) are stranded by 120 degrees in a clockwise direction (A direction of FIG. 6A) from the position of FIG. 5A to the position of FIG. 6A which is shifted by ⅓ spiral pitch, the optical fiber ribbons 30 are individually and respectively “stranded back” so as to be stranded by 120 degrees in a counterclockwise direction.

Therefore, the optical fiber ribbon 30a arranged at the uppermost stage in FIG. 5B is arranged on the right side toward the opening of the slot groove 14 at the third stage from the opening side of the slot groove 14 in FIG. 6B (the position shifted by ⅓ spiral pitch from the position in FIG. 5A). Positions of the optical fiber ribbons 30b to 30f are also changed in the same manner, the optical fiber ribbon 30e is arranged at the stage closest to the opening side of the slot groove 14, and the optical fiber ribbon 30d and the optical fiber ribbon 30f are arranged in parallel on the right side and the left side toward the opening of the slot groove 14 at the second stage from the opening side of the slot groove 14. Similarly, the optical fiber ribbon 30c and the optical fiber ribbon 30a are arranged in parallel on the right side and the left side toward the opening of the slot groove 14 at the third stage from the opening side of the slot groove 14, and the optical fiber ribbon 30b is arranged at the fourth stage from the opening side of the slot groove 14.

In FIG. 6B, the optical fiber ribbons 30 (30a to 30f) are arranged such that width directions in which the optical fibers 31 are arranged in parallel in all the optical fiber ribbons 30 (30a to 30f) are substantially parallel to the opening of the slot groove 14, as in the case of FIG. 5B. As described above, also at the position of FIG. 6A which is shifted by ⅓ spiral pitch from the position of FIG. 5A, the width directions in which the optical fibers 31 are arranged in parallel in all the optical fiber ribbons 30 (30a to 30f) are aligned.

That is, when the optical fiber ribbons 30 (30a to 30f) are viewed in the longitudinal direction, torsion is not generated in the optical fiber ribbons 30 (30a to 30f). At positions other than the position shifted by ⅓ spiral pitch of the optical fiber cable 10 in the longitudinal direction, the torsion is not generated in the optical fiber ribbons 30 (30a to 30f) as in FIG. 6B.

If the stranding back does not occur, the torsion is generated in the optical fiber ribbons, and the orientations and positions of the optical fiber ribbons become irregular.

As described above, the term “strand back” in the present embodiment means that the optical fiber ribbons are stranded in an orientation in which the torsion of the optical fiber ribbons generated when the optical fiber ribbons are stranded with each other is eliminated.

The intermittent connection-type optical fiber ribbon 30 in this example includes twelve optical fibers 31A to 31L. The optical units 20 each includes six optical fiber ribbons 30, and includes a total of 72 optical fibers 31. Since five optical units 20 are accommodated in one slot groove 14, a total of 360 optical fibers 31 are accommodated in the slot groove 14. Since five slot grooves 14 are provided in the slot rod 11, a total of 1800 optical fibers 31 are accommodated in the optical fiber cable 10.

In such an optical fiber cable 10, an occupancy rate calculated based on a cross-sectional area of the optical unit 20 with respect to a cross-sectional area of the slot groove 14, that is, a ratio of a total cross-sectional area of the optical fiber ribbons 30 to the cross-sectional area of the slot groove 14 is 25% or more and 65% or less. When a stranding pitch of the optical fiber ribbons 30 is P1 and the stranding pitch of the slot grooves 14 is P2, a composite stranding pitch Pmix obtained by 1/Pmix=1/P1+1/P2 is 200 mm or more and 400 mm or less.

Note that, in FIGS. 5A to 6B, in order to facilitate understanding of the stranding back and the like, a plurality of optical fiber ribbons 30 included in the optical unit 20, which are six optical fiber ribbons 30, are illustrated to be arranged in the width direction in a substantially straight state, and the plurality of the optical fiber ribbons 30 are illustrated to be stacked in a direction perpendicular to the width direction, but the state of the optical fiber ribbons 30 is not limited thereto. For example, the six optical fiber ribbons 30 included in the optical unit 20 may be in a state in which the six optical fiber ribbons 30 are individually and respectively gathered so as to be gathered together. In this case, the gathered optical fiber ribbons 30 are stranded back along the longitudinal direction of the optical fiber cable 10 and stranded in the spiral shape in one direction.

According to the optical fiber cable 10, the plurality of optical units 20 are respectively accommodated in the plurality of slot grooves 14 in the spiral shape stranded in one direction along the longitudinal direction of the optical fiber cable 10 in a state in which the relative positional relationship between the optical units 20 and the slot groove 14 does not change and the relative positional relationship between the optical units 20 does not change. Therefore, intermediate branching is likely to occur, and a desired optical fiber ribbon 30 in the optical unit 20 accommodated in the slot groove 14 can be easily taken out at the time of the intermediate branching. In addition, according to the optical fiber cable 10, since the optical fiber ribbons 30 are accommodated in the slot grooves 14 in a state of being stranded with each other, for example, even when the optical fiber cable 10 is bent, the optical fiber ribbons 30 can be prevented from protruding out of the slot grooves 14 due to an influence of compressive strain. Therefore, it is possible to prevent deterioration of transmission characteristics caused by the protrusion of the optical fiber ribbons 30.

In addition, in the optical fiber cable 10, an increase in transmission loss is prevented by setting the composite stranding pitch Pmix calculated in consideration of two pitches of the stranding pitch P1 of the optical fiber ribbons 30 and the stranding pitch P2 of the slot grooves 14 to 200 mm or more and 400 mm or less as described above.

For example, when the composite stranding pitch Pmix is less than 200 mm, since the stranding pitch is short, the optical fiber 31 per unit length of the optical unit 20 becomes long, a volume of the optical units 20 increases, and the transmission loss due to microbend may increase. In addition, for example, when the composite stranding pitch Pmix exceeds 400 mm, the stranding pitch of the slot grooves 14 becomes long, so that cancellation (counterbalancing) of a tensile stress on a cable upper side and a compressive stress on a cable lower side at the time of cable bending becomes insufficient, and the transmission loss due to the bending may increase.

In the optical fiber cable 10, since the composite stranding pitch Pmix is 200 mm or more, it is possible to prevent the increase in transmission loss due to the microbend. In addition, in the optical fiber cable 10, since the composite stranding pitch Pmix is 400 mm or less, it is possible to prevent the increase in transmission loss due to the bending of the optical fiber cable. Therefore, the optical fiber cable 10 can obtain good transmission characteristics.

In addition, according to the optical fiber cable 10, the optical fiber ribbons 30 are stranded in the state of stranding back. Therefore, the torsion of the optical fiber ribbons 30 caused when the optical fiber ribbons 30 are stranded with each other can be eliminated by stranding the optical fiber ribbons 30 in the orientation in which the torsion thereof is eliminated. Therefore, it is possible to prevent an occurrence of a macrobend loss caused by the torsion of the optical fiber ribbons 30.

According to the optical fiber cable 10, the occupancy rate of the optical unit 20 calculated based on the cross-sectional area of the plurality of optical units 20 with respect to the cross-sectional area of the slot groove 14 is 25% or more and 65% or less. By setting the occupancy rate of the optical unit 20 to 65% or less, for example, even when the optical fiber cable 10 is bent in an arc shape, the compressive strain is dispersed without being concentrated on a part of the optical fibers 31, and thus, the occurrence of the macrobend loss can be prevented, and cable bending characteristics can be improved. In addition, by setting the occupancy rate of the optical unit 20 to 25% or more, it is possible to increase a density of the optical fibers 31 in the optical fiber cable 10. Therefore, by setting the occupancy rate of the optical unit 20 to 25% or more and 65% or less, even the optical fiber ribbons 30 are mounted in the slot grooves 14 at high density, the transmission loss of the optical fibers 31 can be reduced to be small.

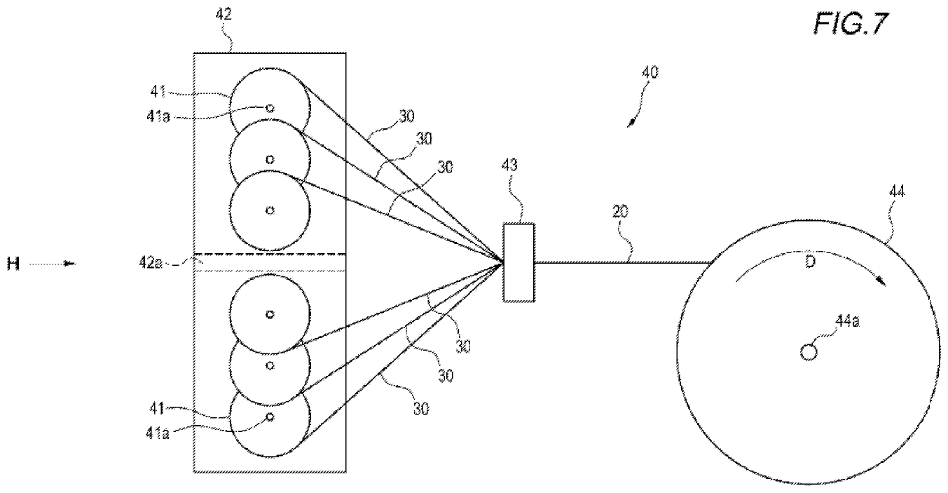

Next, a manufacturing method for the optical fiber cable 10 will be described with reference to FIGS. 7 to 9.

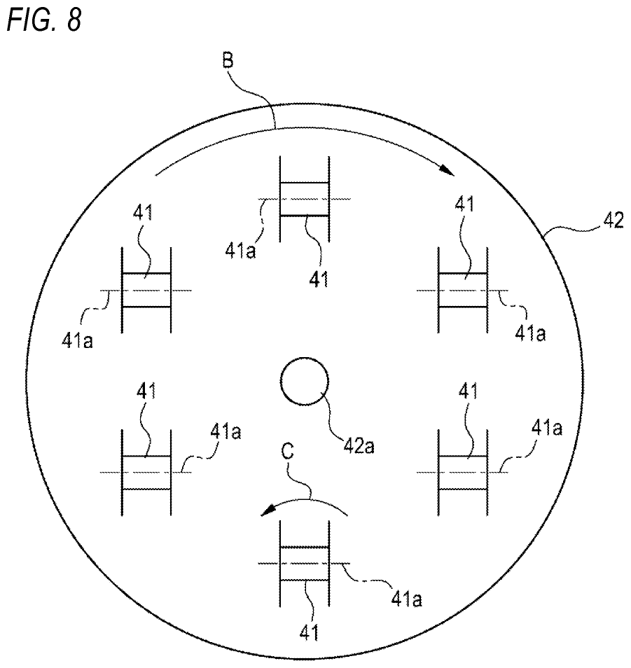

First, a process of manufacturing the optical unit 20 accommodated in the slot groove 14 of the optical fiber cable 10 will be described with reference to FIGS. 7 and 8.

As shown in FIG. 7, the optical fiber ribbons 30 are sent toward a joint butt strap 43 from supply bobbins 41 attached to a cage 42 in a manufacturing device 40 of the optical unit 20. The supply bobbins 41 whose number corresponds to the number of optical fiber ribbons 30 included in the optical unit 20 to be manufactured is attached to the cage 42. In this example, six supply bobbins 41 are attached to the cage 42.

As shown in FIG. 8, the supply bobbins 41 are attached to the cage 42 in a ring shape around a rotation shaft 42a of the cage 42. The supply bobbins 41 respectively rotate around the rotation shaft 41a to send the optical fiber ribbons 30 wound around the supply bobbins 41 to the joint butt strap 43.

As shown in FIG. 8, the cage 42 rotates in an arrow B direction around the rotation shaft 42a of the cage 42 (right rotation) while the optical fiber ribbons 30 are sent from the supply bobbins 41. By this rotation, the optical fiber ribbons 30 sent from the supply bobbins 41 are stranded with each other in the spiral shape stranded in one direction. The cage 42 rotates at a predetermined speed according to a roll up speed of a roll up drum 44 (see FIG. 7), so that a stranding pitch of the optical fiber ribbons 30 to be stranded becomes a predetermined pitch.

In addition, as shown in FIG. 8, each supply bobbin 41 rotates in an arrow C direction (left rotation) with respect to the cage, so that a direction of the rotation shaft 41a of each supply bobbin 41 is maintained in a constant direction (horizontal direction in this example) while the cage 42 rotates in the arrow B direction. That is, each supply bobbin 41 rotates in a direction (the arrow C direction) opposite to the rotation direction (the arrow B direction) of the cage 42, so that the supply bobbins 41 always face the same orientation on the cage 42. By this rotation, the respective optical fiber ribbons 30 are stranded back at the time of being stranded with each other, and stranded with each other without generating the torsion in the optical fiber ribbons 30. The direction of the rotating shaft 41a of each supply bobbin 41 to be maintained is not limited to the horizontal direction, and may be maintained in a direction at another angle.

As shown in FIG. 7, the manufactured optical unit 20 is wound around the roll up drum 44 that rotates in an arrow D direction around a rotation shaft 44a.

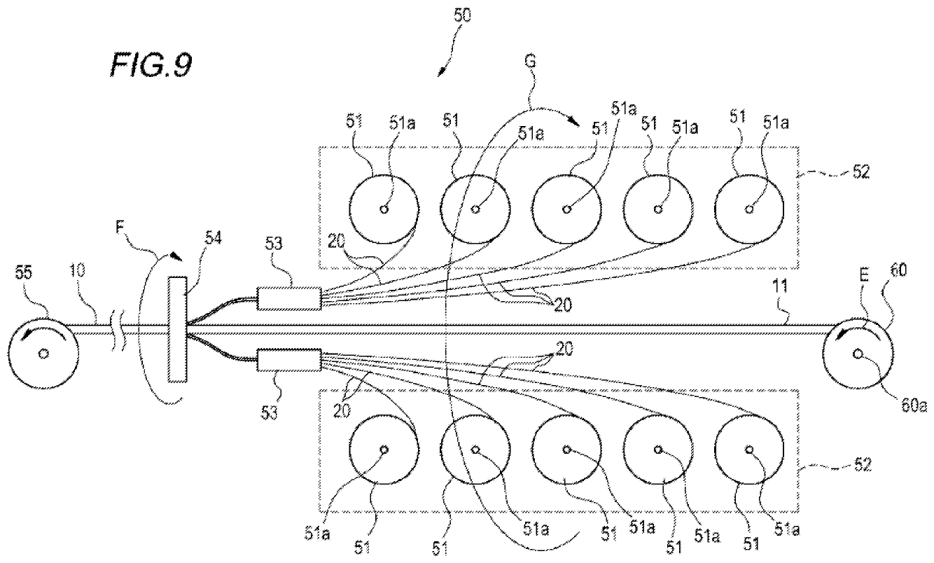

Next, a process of accommodating the optical units 20 in the slot grooves 14 of the optical fiber cable 10 will be described with reference to FIG. 9. Although the number of slot grooves 14 in the optical fiber cable 10 of the present example is five, only the optical units 20 and mechanisms related to line concentration of the optical units 20 for two slot grooves 14 are illustrated in FIG. 9 for simplification of the drawing.

As shown in FIG. 9, in the manufacturing device 50 of the optical fiber cable 10, a drawing-out bobbin 60 of the slot rod rotates in an arrow E direction around a rotation shaft 60a. As a result, the slot rod 11 wound around the drawing-out bobbin 60 is sent toward a joint butt strap 54.

In addition, each of supply bobbins 51 attached to each cage 52 rotates around a rotation shaft 51a. As a result, the optical units 20 wound around the supply bobbins 51 are sent toward line concentration dies 53. The optical units 20 manufactured in the process of manufacturing the optical unit 20 are wound around the supply bobbins 51. The supply bobbins 51 whose number corresponds to the number of optical units 20 accommodated in each of the slot grooves 14 of the slot rod 11 are attached to each cage 52. In this example, five supply bobbins 51 are attached to the cage 52. A provided number of cages 52 corresponds to the number of slot grooves 14 provided in the slot rod 11. In this example, five cages 52 are provided (in FIG. 9, only two cages 52 are illustrated, and the rest of cages 52 are omitted).

The five optical units 20 sent to the line concentration die 53 are concentrated by the line concentration die 53 so as to be accommodated at predetermined positions (opening side, bottom side, and the like) in the slot groove 14. The five optical units 20 concentrated by the line concentration die 53 are sent out toward the joint butt strap 54.

The joint butt strap 54 rotates in an arrow F direction around a rotation shaft (not shown). The joint butt strap 54 rotates at a speed corresponding to a speed of the slot rod 11 sent from the drawing-out bobbin 60. As a result, the five optical units 20 sent from the supply bobbins 51 of the cage 52 are disposed at the predetermined positions of the predetermined slot groove 14 in the slot rod 11 and are accommodated therein.

The five cages 52 rotate as a whole in an arrow G direction around a rotation shaft of the cages (not shown). The five cages 52 as a whole rotate at a rotation pitch corresponding to the stranding pitch of the slot grooves 14 in the same direction as the stranding direction of the spiral slot grooves 14 in which the optical units 20 are accommodated. As a result, the five optical units 20 sent out from the line concentration die 53 are accommodated in the slot groove 14 without being stranded back in a state in which the optical units 20 are not stranded with each other. That is, the five optical units 20 are accommodated in the slot groove 14 without changing the relative positional relationship between the optical units 20 and the slot groove 14. In addition, the five optical units 20 in the slot groove 14 are accommodated in the slot groove 14 without changing the relative positional relationship between the optical units 20. In the slot groove 14, for example, the optical units 20 positioned on the bottom side of the slot groove 14 is always accommodated on the bottom side, and the optical units 20 positioned on the opening side of the slot groove 14 is always accommodated on the opening side.

Instead of the rotation of the cages 52 in the arrow G direction and the rotation of the joint butt strap 54 in the arrow F direction, the roll up drum 55 and the drawing-out bobbin 60 may rotate in the arrow G direction (arrow F direction) (for example, in synchronization with each other at a rotation speed).

Although not shown, in the slot rod 11 in which the optical units 20 are accommodated in each slot groove 14, the wrapping tape 12 and the cable sheath 13 are formed on an outer periphery thereof. Then, the manufactured optical fiber cable 10 is wound around the roll up drum 55.

In the manufacturing method described above, the process of manufacturing the optical unit 20 and the process of accommodating the optical unit 20 in the slot groove 14 are separately described, but the processes may be performed in the same process.

According to the manufacturing method for optical fiber cable, the plurality of optical units 20 are respectively accommodated in the plurality of slot grooves 14 in the spiral shape stranded in one direction along the longitudinal direction of the optical fiber cable 10 in a state in which the relative positional relationship between the optical units 20 and the slot groove 14 does not change and the relative positional relationship between the optical units 20 does not change, so that the optical fiber cable 10 can be manufactured. In the optical fiber cable 10 manufactured by the above manufacturing method, a desired optical fiber ribbon can be easily taken out at the time of the intermediate branching.

### EXAMPLE

Samples No. 1 to 13 of optical fiber cables having the same cross-sectional structure as that of the optical fiber cable 10 shown in FIG. 1 and having different stranding pitches of the optical fiber ribbons 30 and different stranding pitches of the slot grooves 14 were prepared.

Samples No. 1 to 13 were produced by producing an optical unit using six optical fiber ribbons 30 shown in FIG. 4 and accommodating five optical units in each of five slot grooves 14. Therefore, 1800 optical fibers 31 are accommodated in the optical fiber cable of each sample. An occupancy rate of the optical fiber cable of each sample (total cross-sectional area of the optical fiber ribbons/cross-sectional area of the slot grooves) was 50%. In the optical fiber ribbon 30, as shown in FIG. 4, an intermittent pattern is formed every two optical fibers, and a length of the connecting portion 32 is 30 mm and a length of the non-connecting portion 33 is 120 mm.

Samples No. 1 to 4 are comparative examples, and are optical fiber cables having a configuration in which the optical units in the slot grooves 14 are stranded with each other.

Samples No. 5 to 13 are examples, and are optical fiber cables having a configuration in which the optical units in the slot grooves 14 are not stranded with each other.

A transmission loss was measured and intermediate branching property was evaluated for each of the above samples. Evaluation results thereof are shown in Table 1 below.

TABLE 1

| | stranding pitch P1 | | stranding | composite | | |
|---|---|---|---|---|---|---|
| | (mm) of optical | | pitch P2 | stranding | | intermediate |
| sample | fiber ribbon | stranding of | (mm) of | pitch | transmission | branching |
| No. | in optical unit | optical units | slot groove | Pmix (mm) | loss (dB/mm) | property |
| 1 | 250 | Stranded | 600 | 176 | 0.35 | C |
| 2 | 500 | Stranded | 600 | 273 | 0.33 | C |
| 3 | 750 | Stranded | 600 | 333 | 0.27 | C |
| 4 | 1000 | Stranded | 600 | 375 | 0.21 | C |
| 5 | 250 | Not Stranded | 600 | 176 | 0.29 | B |
| 6 | 500 | Not Stranded | 600 | 273 | 0.21 | A |
| 7 | 750 | Not Stranded | 600 | 333 | 0.22 | A |
| 8 | 1000 | Not Stranded | 600 | 375 | 0.23 | A |
| 9 | 250 | Not Stranded | 1200 | 207 | 0.20 | A |
| 10 | 500 | Not Stranded | 1200 | 353 | 0.23 | A |
| 11 | 750 | Not Stranded | 1200 | 462 | 0.25 | A |
| 12 | 1000 | Not Stranded | 1200 | 545 | 0.32 | A |
| 13 | 1200 | Not Stranded | 1200 | 600 | 0.35 | A |

In Table 1, the composite stranding pitch Pmix represents a stranding pitch obtained by combining the stranding pitch P1 of the optical fiber ribbon 30 and the stranding pitch P2 of the slot groove 14. Since a value of Pmix is obtained by the equation of 1/Pmix=1/P1+1/P2, the value of Pmix is changed by changing at least one value of the stranding pitch P1 of the optical fiber ribbon 30 and the stranding pitch P2 of the slot groove 14.

The intermediate branching property was determined based on how long a desired optical fiber ribbon can be taken out (extra length) when the cable sheath 13 and the wrapping tape 12 corresponding to 1.5 m of an intermediate portion of the optical fiber cable were peeled off and an connection operation at the time of the intermediate branching was performed.

When a desired optical fiber ribbon can be taken out with an extra length of 50 cm or more, the intermediate branching was considered to be easy to perform, and the intermediate branching property was evaluated as A. When the desired optical fiber ribbon can be taken out with an extra length of 30 cm or more and less than 50 cm, the intermediate branching was considered to be able to perform, and the intermediate branching property was evaluated as B. In addition, when the desired optical fiber ribbon can be taken out only with an extra length of less than 30 cm, the intermediate branching was considered to be difficult to perform, and the intermediate branching property was evaluated as C.

As shown in the results of Table 1, in the samples No. 5 to 13 of the examples, the evaluation result of the intermediate branching property was A or B, and the intermediate branching property was good.

On the other hand, in the samples No. 1 to 4 as the comparative examples, the evaluation results of the intermediate branching property were C. In the samples No. 1 to 4, since the optical units are stranded with each other, the relative positional relationship between the optical units and the slot groove 14 in the spiral shape stranded in one direction changes in the longitudinal direction of the optical fiber cable. In the samples No. 1 to 4, the relative positional relationship between the optical units also changes in the longitudinal direction of the optical fiber cable. Therefore, it is considered that the evaluation result of the intermediate branching property is C in the samples No. 1 to 4.

In the measurement of the transmission loss, a bending loss of the optical fiber cable with respect to signal light at a wavelength of 1.55 μm was measured when the optical fiber cable of each sample was bent in an arc shape having φ 500 mm.

Among the samples No. 5 to 13 of the example, the samples No. 6 to 10 had numerical values of the transmission loss of less than 0.25 dB/km, and transmission characteristics were good. The composite stranding pitch Pmix of the samples No. 6 to 10 is in the range of 200 mm or more and 400 mm or less. Based on this, it was found that the optical fiber cable of the example can obtain good transmission characteristics by setting the composite stranding pitch Pmix in the range of 200 mm or more and 400 mm or less.

Although the present invention are described in detail with reference to the specific embodiment, it will be apparent to those skilled in the art that various changes and modifications can be made without departing from the spirit and scope of the present invention. The numbers, positions, shapes, and the like of components described above are not limited to the embodiment described above and can be changed to suitable numbers, positions, shapes, and the like on a premise that the present invention is achieved.

### REFERENCE SIGNS LIST

10: optical fiber cable

11: slot rod

12: wrapping tape

13: cable sheath

14: slot groove

14a: both side wall portions

14b: bottom portion

15: tensile strength member

20 (20A to 20E): optical unit

30 (30a to 30f): optical fiber ribbon

31 (31A to 31L): optical fiber

32: connecting portion

33: non-connecting portion

40: manufacturing device of optical unit 20

41: supply bobbin

41a: rotation shaft

42: cage

42a: rotation shaft

43: joint butt strap

44: roll up drum

44a: rotation shaft

50: manufacturing device of optical fiber cable 10

51: supply bobbin

51a: rotation shaft

52: cage

53: line concentration dies

54: joint butt strap

55: roll up drum

60: drawing-out bobbin

60a: rotation shaft

1. An optical fiber cable comprising:
a slot rod that is provided with a plurality of slot grooves in a spiral shape stranded in one direction;
a tensile strength member that is provided inside the slot rod and configured to receive tension;
a cable sheath that covers an outer side of the slot rod; and
a plurality of optical units each of which is made by gathering optical fiber ribbons in which a plurality of optical fibers is arranged in parallel,
wherein, in each of the optical units, the optical fiber ribbons are stranded with each other along a longitudinal direction of the optical fiber cable,
each of the optical units is accommodated in corresponding one of the slot grooves along the longitudinal direction of the optical fiber cable in a state where relative positional relationships between the optical units and the slot grooves are kept and relative positional relationships between the optical units are kept.

2. The optical fiber cable according to claim 1,
wherein a stranding direction of the optical fiber ribbons is the same as a stranding direction of the slot grooves in the spiral shape stranded in one direction, and
when a stranding pitch of the optical fiber ribbons is P1 and a stranding pitch of the slot grooves is P2, a composite stranding pitch Pmix obtained by 1/Pmix=1/P1+1/P2 is 200 mm or more and 400 mm or less.

3. The optical fiber cable according to claim 1,
wherein an occupancy rate of the optical unit calculated based on a cross-sectional area of the plurality of optical units with respect to a cross-sectional area of the slot groove is 25% or more and 65% or less.

4. The optical fiber cable according to claim 1,
wherein, in the plurality of optical units, the optical fiber ribbons are stranded in a state of stranding back.

5. A manufacturing method for an optical fiber cable including:
a slot rod that is provided with a plurality of slot grooves in a spiral shape stranded in one direction;
a tensile strength member that is provided inside the slot rod and configured to receive tension;
a cable sheath that covers an outer side of the slot rod; and
a plurality of optical units each of which is made by gathering optical fiber ribbons in which a plurality of optical fibers is arranged in parallel,
the method comprising:
forming the optical unit by stranding back the plurality of optical fiber ribbons sent out from supply units of the optical fiber ribbons so as to be stranded with each other; and
accommodating the plurality of optical units in the slot grooves along a longitudinal direction of the optical fiber cable in a state where relative positional relationships between the optical units and the slot grooves are kept and relative positional relationships between the optical units are kept.
